(19) United States
(12) Patent Application Publication
(10) Pub. No.: US 2015/0118076 A1
(43) Pub. Date: Apr. 30, 2015

(54) COMPRESSOR WITH IMPROVED VALVE ASSEMBLY

(71) Applicant: Emerson Climate Technologies, Inc., Sidney, OH (US)

(72) Inventor: Walter T. Grassbaugh, Sidney, OH (US)

(73) Assignee: Emerson Climate Technologies, Inc., Sidney, OH (US)

(21) Appl. No.: 14/068,399

(22) Filed: Oct. 31, 2013

(51) Int. Cl. F04C 28/24; G05D 23/08; F16K 31/00; F16K 15/14; F04C 18/02; F01C 21/02

(52) U.S. Cl. CPC F04C 28/24; F04C 18/0215; F01C 21/02; F16K 31/002; F16K 15/145; G05D 23/08
USPC 417/292; 137/468; 236/101 R

(57) ABSTRACT

A thermal-valve assembly for a compressor including a partition plate having a first bore formed therethrough is provided. The thermal-valve assembly may include a body having a wall extending from and surrounding a bottom wall. The bottom wall may include a first surface defining a valve seat, a second surface formed on an opposite side of the bottom wall than the first surface and facing the partition plate, and a second bore extending through the bottom wall between the first surface and the second surface and aligned with the first bore. A projection may extend from the second surface and may be attached to the partition plate. A valve element may be received by the body and may be supported on the valve seat between an open state permitting communication through the second bore and a closed state preventing communication through the second bore.

### FIELD

The present disclosure relates generally to compressors, and more particularly to a compressor having an improved valve assembly.

### BACKGROUND

The statements in this section merely provide background information related to the present disclosure and may not constitute prior art.

A scroll compressor generally includes a hermetic shell defining a chamber and a partition plate dividing the chamber into a discharge-pressure zone and a suction-pressure zone. A scroll assembly may be located within the chamber for compressing a working fluid disposed within the chamber. As the working fluid is compressed in the scroll assembly, the compressed fluid exits the center discharge port of the scroll assembly and enters the discharge-pressure zone. The compressed working fluid may then be discharged to a fluid circuit such as a refrigeration circuit through a discharge port formed in the hermetic shell.

Compression of the fluid within the chamber of the scroll compressor may cause a temperature within the discharge-pressure zone to rise. A thermal-valve may be provided between the discharge-pressure zone and the suction-pressure zone to allow fluid to leak from the discharge-pressure zone to the suction-pressure zone when a temperature within the discharge-pressure zone exceeds a threshold value. Allowing the fluid to leak from the discharge-pressure zone to the suction-pressure zone when a temperature within the discharge-pressure zone exceeds a predetermined value reduces the temperature within the discharge-pressure zone.

### SUMMARY

A thermal-valve assembly for a compressor including a partition plate having a first bore formed therethrough is provided. The thermal-valve assembly may include a body having a wall extending from and surrounding a bottom wall. The bottom wall may include a first surface defining a valve seat, a second surface formed on an opposite side of the bottom wall than the first surface and facing the partition plate, and a second bore extending through the bottom wall between the first surface and the second surface and aligned with the first bore. A projection may extend from the second surface and may be attached to the partition plate. A valve element may be received by the body and may be supported on the valve seat between an open state permitting communication through the second bore and a closed state preventing communication through the second bore.

In another configuration, a compressor is provided and may include a partition plate, a first bore formed through the partition plate, and a thermal-valve assembly. The thermal-valve assembly may include a body having a wall extending from and surrounding a bottom wall. The bottom wall may include a first surface defining a valve seat, a second surface formed on an opposite side of the bottom wall than the first surface and facing the partition plate, and a second bore extending through the bottom wall between the first surface and the second surface and aligned with the first bore. A projection may extend from the second surface and may be attached to the partition plate. A valve element may be received by the body and may be supported on the valve seat between an open state permitting communication through the second bore and a closed state preventing communication through the second bore.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a cross-sectional view of a compressor in accordance with the teachings of the present disclosure;

FIG. 2 is a top perspective view of a thermal-valve assembly in accordance with the teachings of the present disclosure;

FIG. 3 is a bottom perspective view of a thermal-valve assembly in accordance with the teachings of the present disclosure;

FIG. 4 is a top view of a thermal-valve assembly in accordance with the teachings of the present disclosure;

FIG. 5 is a cross-sectional view of a thermal-valve assembly taken along line 5-5 of FIG. 4;

FIG. 6 is a cut-away view of a thermal-valve assembly in accordance with the teachings of the present disclosure;

FIG. 7 is a partial perspective view of a partition plate on which a thermal-valve assembly is mounted;

FIG. 8 is a partial cut-away view of a thermal-valve assembly and a partition plate;

FIG. 9 is a cross-sectional view of a thermal-valve assembly mounted to a partition plate, detailing an engagement between the thermal-valve assembly and the partition plate;

FIG. 10 is a cross-sectional view of a thermal-valve assembly mounted to a partition plate;

FIG. 11 is a cross-sectional view of a thermal-valve assembly mounted to a partition plate having a relocated discharge hole;

FIG. 12 a cross-sectional view of a thermal-valve assembly in accordance with the teachings of the present disclosure mounted to a partition plate;

FIG. 13 is a cross-sectional view of a thermal-valve assembly in accordance with the teachings of the present disclosure mounted to a partition plate; and

FIG. 14 is a perspective view of the thermal-valve assembly of FIG. 13, with a valve element of the thermal-value assembly removed for clarity.

Corresponding reference numerals indicate corresponding parts throughout the several views of the drawings.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

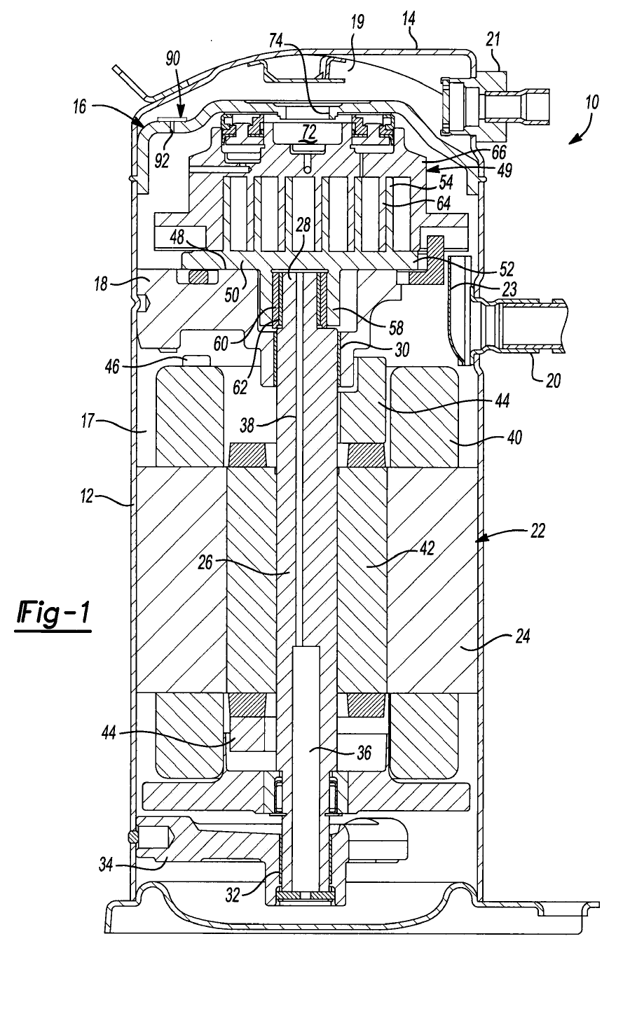

Referring to FIG. 1, a compressor 10 is provided and includes a generally cylindrical hermetic shell 12, a cap 14 welded at an upper end of the shell 12, and a partition plate 16 (or a muffler plate) dividing the shell 12 into a suction-pressure zone 17 and a discharge-pressure zone 19 (or a muffler chamber).

A main-bearing housing 18 may be affixed to the shell 12 at a plurality of points adjacent to the partition plate 16 and may include an annular flat thrust bearing surface 48 and a bearing 30. A second bearing housing 34 may be provided adjacent to a lower portion of the shell 12 and may include a bearing 32.

A motor 22 may be disposed below the main-bearing housing 18 and may include a stator 24 and a rotor 42. The stator 24 may be generally square in cross-section with the corners rounded off and may be press-fit into the shell 12. Flat portions (not shown) of the stator 24—located between the rounded corners of the stator 24—cooperate with the shell 12 to define passageways therebetween to facilitate the flow of lubricant from the top of the shell 12 to the bottom of the shell 12.

A motor protector 46 may be disposed proximate to motor windings 40 to prevent the motor 22 from exceeding a predetermined temperature. When the compressor reaches a threshold temperature, the motor protector 46 may de-energize the motor 22 to stop operation of the compressor 10.

A crankshaft 26 may be press-fitted into the rotor 42 and may be rotatably driven by the rotor 42 with one or more counterweights 44 mounted thereon. The crankshaft 26 may include an upper end provided with an eccentric crank pin 28 and a lower end formed with an oil-pumping concentric bore 36. The eccentric crank pin 28 may be rotatably journaled in and supported by the bearings 30 and 32 at both ends. The oil-pumping concentric bore 36 may communicate with a radially outwardly inclined smaller-diameter bore 38 extending upwardly therefrom to the top of the crankshaft 26. The lower portion of the shell 12 may be filled with lubricating oil. The concentric bore 36 disposed at the bottom of the crankshaft 26 may be the primary pump acting in conjunction with the bore 38, which acts as a secondary pump, to pump lubricating fluid to various portions of the compressor 10 that require lubrication.

A scroll assembly 49 may be supported on the main-bearing housing 18 and may comprise an orbiting-scroll member 50 and a non-orbiting scroll member 66. The orbiting-scroll member 50 may include an end plate 52 contacting the flat thrust bearing surface 48 of the main-bearing housing 18, a spiral vane or wrap 54 extending upwardly from the end plate 52, and a cylindrical hub 58 extending downwardly from the end plate 52.

The cylindrical hub 58 may include a journal bearing 60 that rotatably receives a drive bushing 62. The drive bushing 62 may include an inner bore that drivingly receives the crank pin 28. The engagement between the crank pin 28 and the cylindrical hub 58 may be of the type disclosed in Assignee's commonly owned U.S. Pat. No. 4,877,382, the disclosure which is incorporated herein by reference.

The non-orbiting scroll member 66 may be mounted to the main-bearing housing 18 such that the non-orbiting scroll member 66 may be axially moved towards and away from the main-bearing housing 18. The non-orbiting scroll member 66 may be mounted to the main-bearing housing 18 in the manner disclosed in Assignee's commonly owned U.S. Pat. Nos. 4,877,382 and 5,102,316, the disclosures of which are incorporated herein by reference.

The non-orbiting scroll member 66 includes a wrap 64 positioned in meshing engagement with the wrap 54 of the orbiting-scroll member 50 and a centrally disposed discharge passage 72. The discharge passage 72 communicates with the discharge-pressure zone 19 defined between the end cap 14 and the partition plate 16 through an opening 74.

A suction gas inlet fitting 20 may be disposed outside the shell 12 and a gas deflector 23 may be disposed inside the shell 12 adjacent to the suction gas inlet fitting 20. The cap 14 may include a refrigerant discharge fitting 21, which may include a discharge valve therein (not shown). A thermal-valve assembly 90 may be mounted on the partition plate 16 covering a leakage hole 92 of the partition plate 16. The leakage hole 92 may communicate the suction-pressure zone 17 and the discharge-pressure zone 19.

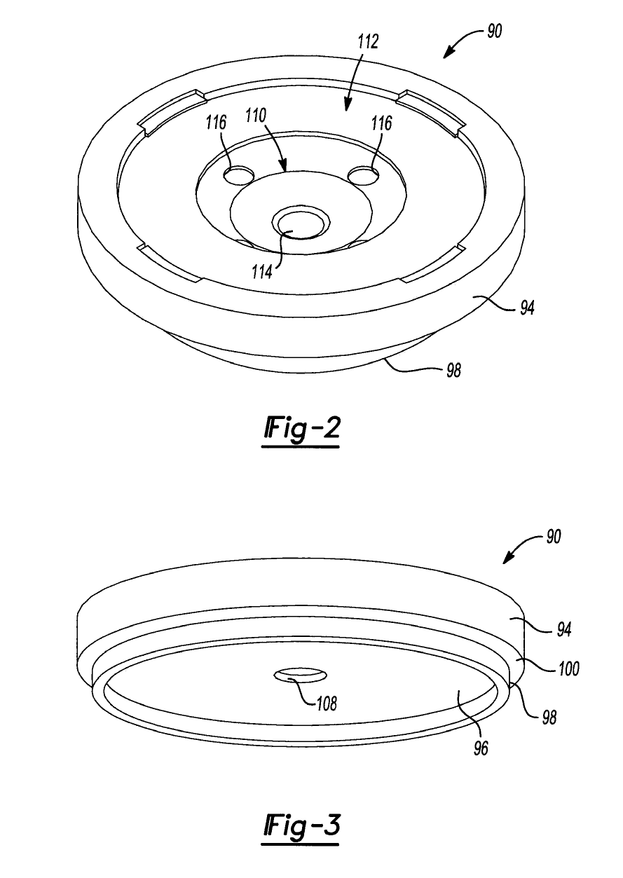

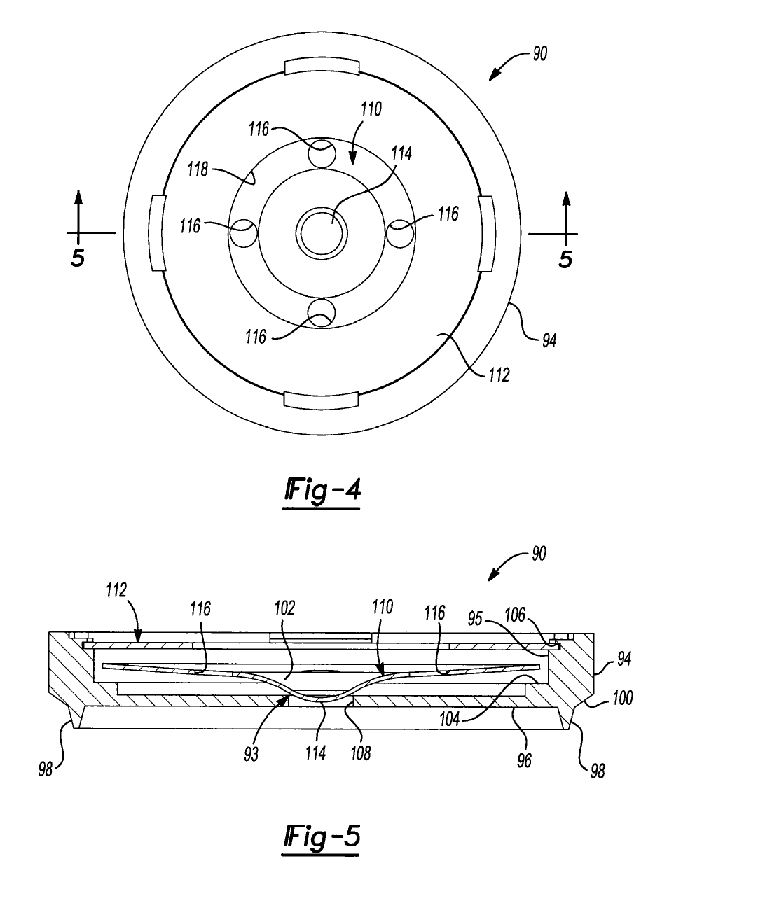

Referring to FIGS. 2-5, the thermal-valve assembly 90 includes a substantially cylindrical body having a cylindrical wall 94, a valve seat 93 surrounded by the cylindrical wall 94, and an annular flange 98. The annular flange 98 may extend from an end of the cylindrical wall 94 and perpendicularly and downwardly from the valve seat 93. An annular shoulder 100 may be formed between the cylindrical wall 94 and the annular flange 98. The bottom wall 96 of the valve seat 93 and the annular flange 98 may cooperate to form a cup shape.

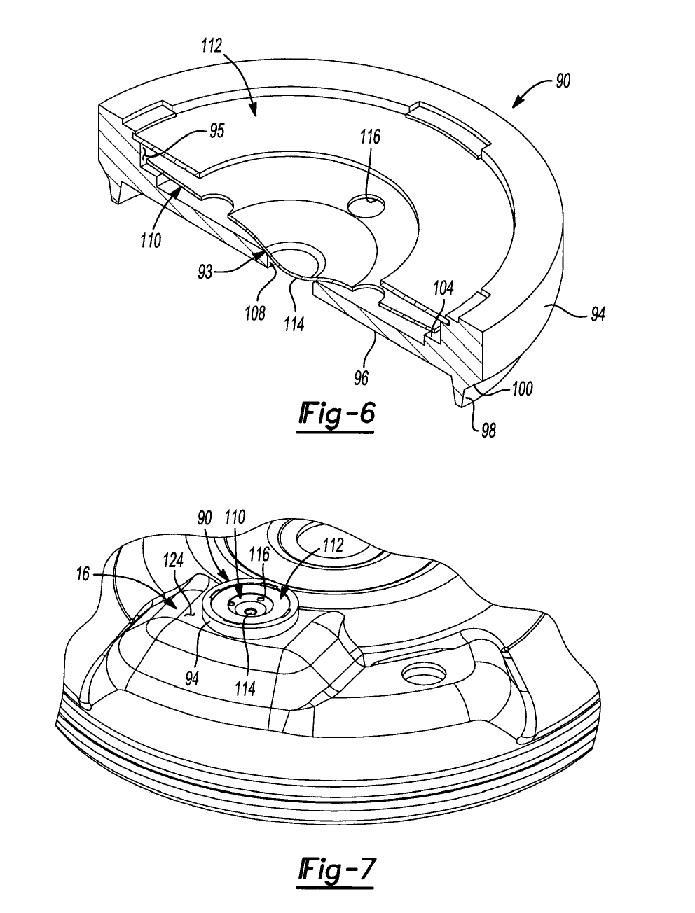

As shown in FIGS. 4 through 6, the cylindrical wall 94 may define an inner space 102. The valve seat 93 may be provided in the inner space 102 and may include the bottom wall 96 and an annular step 104 extending radially and inwardly from an inner surface 95 of the cylindrical wall 94. A central opening 108 may be formed through the bottom wall 96.

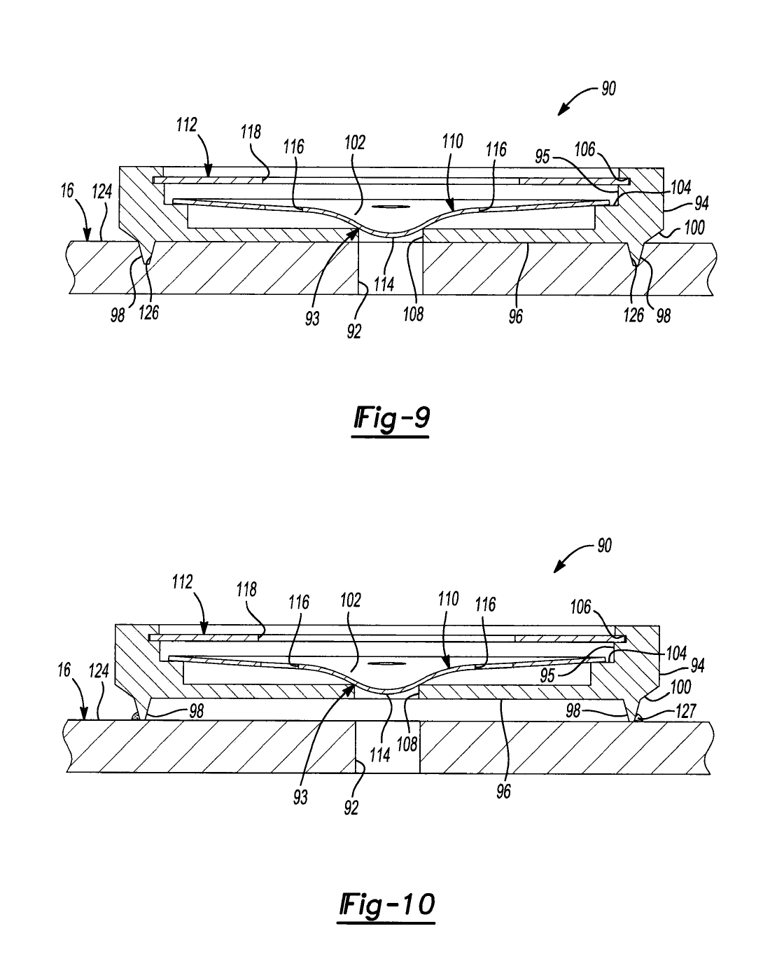

The thermal-valve assembly 90 may further include a valve element 110 and a retainer 112 received in the inner space 102. The valve element 110 may be a bimetallic disc having a central concaved portion 114 and a plurality of apertures 116. The central concaved portion 114 may be concave relative to the retainer 112. It will also be appreciated that the central concaved portion 114 may be convex relative to the central opening 108 and the leakage hole 92. Accordingly, when the thermal-valve assembly 90 is in a closed position, the valve element 110 may be supported on the annular step 104, and the central concaved portion 114 may contact the valve seat 93 generally around the central opening 108 and extend into the central opening 108. When the thermal-valve assembly 90 is in the closed position (FIGS. 9 and 10), the valve element 110 blocks the central opening 108 and prevents discharge-pressure gas from the discharge-pressure zone 19 from entering the suction-pressure zone 17. When the thermal-valve assembly 90 is in an open position, the central concaved portion 114 of the valve element 110 is separated from the valve seat 93 to permit flow between the discharge-pressure zone 19 and the suction-pressure zone 17.

The retainer 112 may be snapped into an inner annular groove 106 formed on the inner surface 95 of the cylindrical wall 94 and may have a ring configuration including a central opening 118. After the valve element 110 is assembled to the cylindrical wall 94, the retainer 112 may be snapped into the annular groove 106 to retain the valve element 110 in the inner space 102 when the valve element 110 is in an open position.

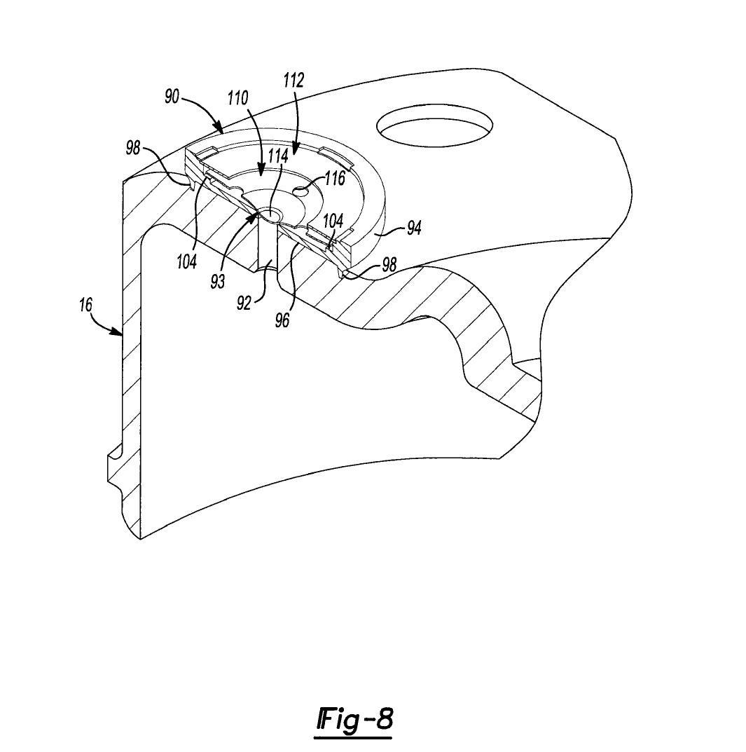

Referring to FIGS. 7-9, the thermal-valve assembly 90 is shown mounted on a planar surface 124 of the partition plate 16. The planar surface 124 is formed adjacent to a leakage hole 92 (FIG. 8) and within the discharge-pressure zone 19. An annular groove 126 (FIG. 9) may be formed in the planar surface 124 adjacent to the leakage hole 92. When the thermal-valve assembly 90 is mounted to the partition plate 16, the annular flange 98 of the thermal-valve assembly 90 may be received within the annular groove 126 such that the central opening 108 of the bottom wall 96 is aligned with the leakage hole 92. For example, the bottom wall 96 of the valve seat 93 may abut the planar surface 124. The thermal-valve assembly 90 may be joined to the partition plate 16 by resistance welding through application of heat and pressure at the interface between the thermal-valve assembly 90 and the partition plate 16.

The annular groove 126 may be eliminated to simplify machining of the partition plate 16. As shown in FIG. 10, the annular flange 98 may be in contact with the planar surface 124. By applying heat and pressure at the annular flange 98, a welded joint 127 around the annular flange 98 may be formed to join the thermal-valve assembly 90 and partition plate 16. Because the sealing of the thermal-valve assembly 90 is achieved through engagement between the valve element 110 and the valve seat 93, the disengagement between the valve seat 93 and the planar surface 124 of the partition plate 16 does not affect the sealing of the thermal-valve assembly 90.

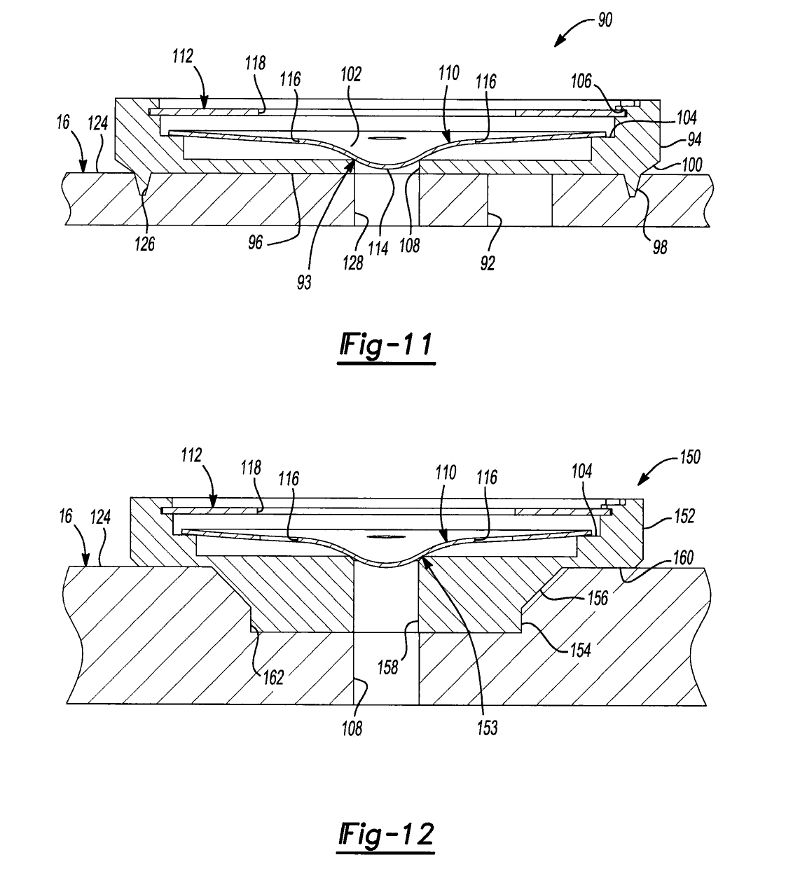

Referring to FIG. 11, when the leakage hole 92 of the partition plate 16 is relocated due to a machining error, for example, the thermal-valve assembly 90 may control opening of a relocated leakage hole 128 while concurrently blocking the originally formed leakage hole 92. Because the bottom wall 96 of the thermal-valve assembly 90 is substantially planar, when the thermal-valve assembly 90 is mounted to the partition plate 16, the bottom wall 96 of the valve seat 93 abuts against the planar surface 124 and blocks the originally formed leakage hole 92, which is no longer needed. Therefore, the thermal-valve assembly 90 allows for reuse of the partition plate 16 when a leakage hole is improperly formed, thereby reducing the number of partition plates that are scrapped during manufacture of the compressor 10. The cylindrical wall 94 may include a diameter that is at least twice a diameter of the leakage hole 92 or 128 to accommodate multiple leakage holes 92, 128 within the cylindrical wall 94.

Referring to FIG. 12, a thermal-valve assembly 150 is provided and may include a cylindrical wall 152 and a valve seat 153 connected to the cylindrical wall 152. The valve seat 153 may include a cylindrical end 154 and a tapered portion 156 with a central opening 158 extending along an axis of the valve seat 153. Like the thermal-valve assembly 90, the thermal-valve assembly 150 may include an annular step 104 extending radially and inwardly from the cylindrical wall 152. An annular shoulder 160 may be formed between the cylindrical wall 152 and the tapered portion 156. When the thermal-valve assembly 150 is mounted to the partition plate 16, the annular shoulder 160 may abut against the planar surface 124 of the partition plate 16 with the tapered portion 156 and the cylindrical end 154 received in a counterbore 162 of the partition plate 16. The thermal-valve assembly 150 may be joined to the partition plate 16 by any conventional joining methods such as, for example, welding or brazing. The other element of the thermal-valve assembly 150 are identical to those of the thermal-valve assembly 90. Accordingly, like reference numerals are used to identify these components.

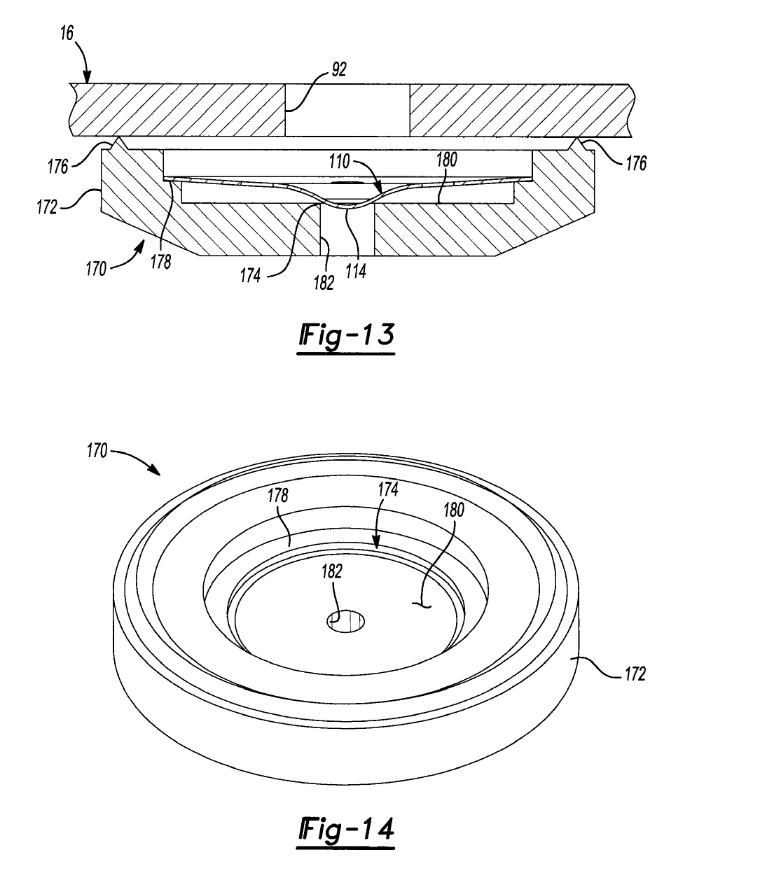

Referring to FIGS. 13 and 14, a thermal-valve assembly 170 is provided. Rather than being mounted in the discharge-pressure zone 19, the thermal-valve assembly 170 is mounted in the suction-pressure zone 17. The thermal-valve assembly 170 may include a cylindrical wall 172, a valve seat 174 provided at a lower end of the cylindrical wall 172, and an annular flange 176 provided at an upper end of the cylindrical wall 172. As with the thermal-valve assembly 150, the other elements of the thermal-valve assembly 170 are identical to those of the thermal-valve assembly 90. Accordingly, like reference numerals are used to identify these components.

The annular flange 176 may extend from the upper end of the cylindrical wall 172. The valve seat 174 may include an annular step 178 extending radially and inwardly from the cylindrical wall 172 and a bottom surface 180. An opening 182 may be formed at the bottom surface 180 for communicating to the leakage hole 92 of the partition plate 16. A valve element 110 may be supported on the annular step 178 and may be disposed adjacent to the bottom surface 180 with the central concaved portion 114 extending into the opening 182. The thermal-valve assembly 170 may be joined to the partition plate 16 by resistance-welding the annular flange 176.

The valve element 110 is spaced from the partition plate 16 such that when the valve element 110 is in the open state (i.e., the valve element 110 is deflected and the central concaved portion 114 is moved away from the opening 182), the valve element 110 contacts the partition plate 16 and is restrained by the partition plate 16. Because the partition plate 16 helps retain the valve element 110 inside the cylindrical wall 172 in the open state, a retainer for retaining the valve element 110 may be eliminated. The leakage hole 92 of the partition plate 16 and the opening 182 of the valve seat 174 may include different diameters.

An easily machinable material may be used to form the valve seats 93, 153, or 174 because the valve seats 93, 153, or 174 are not provided in the partition plate 16, which is generally made of a material of poor machinability. Therefore, manufacturing costs associated with the thermal-valve assemblies 90, 150, 170 can be reduced. Furthermore, testing of the sealing of the thermal-valve assemblies 90, 150, 170 can be independently conducted without the partition plate 16, thereby facilitating the assembly process.

While the leakage hole 92 and the central opening 108 of the valve seats 93, 153 have been shown to have the same diameter, they can be made to have different diameters without affecting the sealing of the thermal-valve assemblies 90, 150, as sealing of the thermal-valve assemblies 90, 150 is achieved through the engagement between the valve elements and valve seats of the respective assemblies 90, 150. Accordingly, any burrs formed around the leakage hole 92 will not affect the sealing of any of the thermal-valve assemblies 90, 150, 170.

It should be understood and appreciated that the thermal-valve assembly can have a configuration different from those described in the present disclosure. Further, it should be understood and appreciated that the retainer and the corresponding annular groove can be eliminated. Instead, a cover or any retaining device can be provided in the thermal-valve assembly to achieve the purpose of retaining the valve element in the inner space of the cylindrical wall.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A thermal-valve assembly for a compressor including a partition plate having a first bore formed therethrough, the thermal-valve assembly comprising:
a body including a wall extending from and surrounding a bottom wall, said bottom wall including a first surface defining a valve seat, a second surface formed on an opposite side of said bottom wall than said first surface and facing the partition plate, and a second bore extending through said bottom wall between said first surface and said second surface and aligned with the first bore;
a projection extending from said second surface and attached to the partition plate; and
a valve element received by said body and supported on said valve seat between an open state permitting communication through said second bore and a closed state preventing communication through said second bore.

2. The thermal-valve assembly of claim 1, wherein said valve element is a bimetallic disc.

3. The thermal-valve assembly of claim 1, wherein said valve seat is spaced apart and separated from the first bore by said bottom wall.

4. The thermal-valve assembly of claim 1, wherein said valve element includes a central portion extending into said second bore of said bottom wall.

5. The thermal-valve assembly of claim 1, wherein said valve element includes a convex portion extending into said second bore of said bottom wall.

6. The thermal-valve assembly of claim 1, further comprising a retainer received in said body for retaining said valve element between said retainer and said first surface of said bottom wall.

7. The thermal-valve assembly of claim 6, wherein said retainer is received by a groove of said cylindrical wall.

8. The thermal-valve assembly of claim 1, wherein said projection is an annular projection that encircles said second bore.

9. The thermal-valve assembly of claim 8, wherein said second surface is spaced apart and separated from the partition plate by said projection.

10. The thermal-valve assembly of claim 8, wherein said projection is received within an annular groove formed in the partition plate.

11. A compressor comprising:
a partition plate;
a first bore formed through said partition plate; and
a thermal-valve assembly comprising:
a body including a wall extending from and surrounding a bottom wall, said bottom wall including a first surface defining a valve seat, a second surface formed on an opposite side of said bottom wall than said first surface and facing said partition plate, and a second bore extending through said bottom wall between said first surface and said second surface and aligned with said first bore;
a projection extending from said second surface and attached to said partition plate; and
a valve element received by said body and supported on said valve seat between an open state permitting communication through said second bore and a closed state preventing communication through said second bore.

12. The compressor of claim 11, wherein said valve element is a bimetallic disc.

13. The compressor of claim 11, wherein said valve seat is spaced apart and separated from said first bore by said bottom wall.

14. The compressor of claim 11, wherein said valve element includes a central portion extending into said second bore of said bottom wall.

15. The compressor of claim 11, wherein said valve element includes a convex portion extending into said second bore of said bottom wall.

16. The compressor of claim 11, further comprising a retainer received in said body for retaining said valve element between said retainer and said first surface of said bottom wall.

17. The compressor of claim 16, wherein said retainer is received by a groove of said cylindrical wall.

18. The compressor of claim 11, wherein said projection is an annular projection that encircles said second bore.

19. The compressor of claim 18, wherein said second surface is spaced apart and separated from said partition plate by said projection.

20. The compressor of claim 18, wherein said projection is received within an annular groove formed in said partition plate.
